(19) United States
(12) Patent Application Publication
(10) Pub. No.: US 2002/0023166 A1
(43) Pub. Date: Feb. 21, 2002

(54) Method for stream merging

(76) Inventors: Amotz Bar-Noy, New York, NY (US); Richard Ladner, Seattle, WA (US)

Correspondence Address: Samuel H. Dworetsky, AT&T CORP., P. O. Box 4110, Middletown, NJ, 07748-4110, US

(21) Appl. No.: 09/829,566

(22) Filed: Apr. 10, 2001

Related U.S. Application Data
(60) Provisional application No. 60/195,972, filed on Apr. 11, 2000.

(51) Int. Cl. G06F 15/16

(52) U.S. Cl. 709/231

(57) ABSTRACT

The present invention is directed to a system and method for stream merging which improves upon the prior art by utilizing optimized merging patterns.

### FIELD OF THE INVENTION

The present invention relates generally to media streaming, and, more particularly, to optimizing multicast delivery of a media stream to a plurality of clients in a communication network.

### BACKGROUND OF THE INVENTION

The simplest policy for serving a media stream to a plurality of clients—e.g., in a video or audio-on-demand system—is to allocate a new media stream for each client request. Such a policy, however, is very expensive, as it requires server bandwidth that scales linearly with the number of clients. One of the most common techniques for reducing server bandwidth is to “batch” multicasted streams into scheduled intervals. Clients that arrive in an interval are satisfied by a full stream at the end of the interval. Bandwidth is saved at the expense of longer guaranteed startup delay.

One recent proposal to reduce server bandwidth is to use a server delivery policy referred to as “stream merging.” See, e.g., D. L. Eager, M. K. Vernon, and J. Zahojan, “Minimizing bandwidth requirements for on-demand data delivery,” Proceedings of the 5^{th} International Workshop on Advances in Multimedia Information Systems (MIS '99), 80-87, 1999. Stream merging assumes that there are multicast media channels and that each client has adequate buffer space and receive bandwidth that is at least twice the playback bandwidth. Under stream merging, the client receives two (or more) channels of the media stream: one channel starting from the beginning of the stream, a second channel commencing mid-stream, e.g. as it is being multicast to other clients who have arrived at an earlier time. The client commences processing of the first channel while buffering the second channel. When the first channel reaches the point in the stream corresponding to the beginning of the buffered stream from the second channel, the client switches to the buffered stream (thereby “merging” the streams) and the transmission on the first channel may be dropped—thereby saving bandwidth.

### SUMMARY OF THE INVENTION

The present invention is directed to a system and method for stream merging which improves upon the prior art by utilizing optimized merging patterns. In accordance with an embodiment of the present invention, the server, channels, and clients in the stream merging architecture have specific and well-defined roles. The server informs the client which streams to monitor and for how long; the server advantageously need only communicate with the client during setup of the media stream. In accordance with another embodiment of the present invention, the server optimizes the merging of multiple client streams by minimizing the cost of different merge patterns. Optimal solutions are disclosed for when stream initiations are both known and unknown ahead of time. Where streams initiations are regular and known ahead of time, optimal merging patterns can be calculated using a novel closed form solution for the merge cost. Where the stream initiations are not regular, the server can utilize the property of monotonicity to quickly calculate optimal merge patterns. Where stream initiations are not known ahead of time, the server can readily decide whether to initiate a new stream or whether to merge the new stream into the existing merge tree, advantageously into the right frontier of the merge tree. The inventors disclose that optimal merge trees have interesting relationships to Fibonacci number recurrences and that a Fibonacci merge tree structure can be advantageously used in an on-line stream merging system.

These and other advantages of the invention will be apparent to those of ordinary skill in the art by reference to the following detailed description and the accompanying drawings.

### BRIEF DESCRIPTION OF THE DRAWINGS

FIG. 1 illustrates a multicast network with a server and multiple clients.

FIG. 2 is a representation of the components of the server and clients in FIG. 1.

FIG. 3 is a timeline illustrating the process of stream merging.

FIG. 4 is a flowchart of processing performed by a client, in accordance with an embodiment of the invention.

FIG. 5 is a flowchart of processing performed by a server using off-line stream merging, in accordance with an embodiment of the invention.

FIG. 6 is a conceptual representation of a merge tree, corresponding to the stream merging example shown in FIG. 3.

FIG. 7 is an abstract diagram illustrating the recursive structure of a merge tree T with root r.

FIG. 8A through 8D are conceptual representations of Fibonacci merge trees for n=3, 5, 8, 13, respectively. FIG. 8E and 8F illustrate two merge trees for n=4.

FIG. 9 shows the values of I(n) for 2≦n≦34.

FIG. 10 is a flowchart of processing performed by a server using on-line stream merging, in accordance with an embodiment of the invention.

FIG. 11 is an abstract diagram illustrating the transformation from Tₙ₋₁ to Tnₙ₋₁ⁱ in the basic merging rule in on-line stream merging.

FIG. 12 is an abstract diagram illustrating the transformation from T to T^{x}.

FIG. 13 is an abstract diagram illustrating the transformation from Tₙ₋₁ to Tₙ₋₁ⁱ in a dynamic tree algorithm.

### DETAILED DESCRIPTION

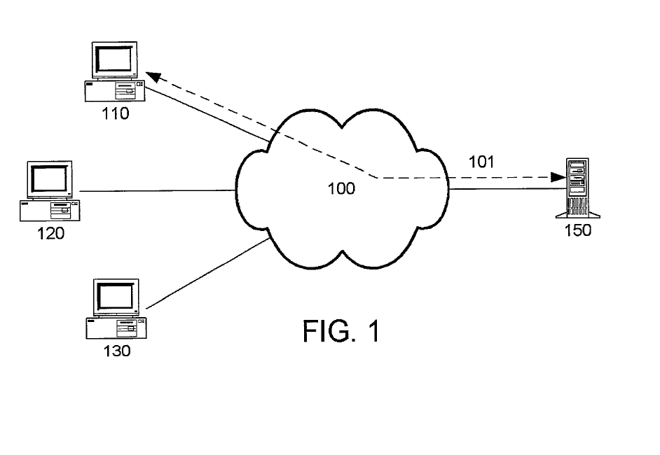

In FIG. 1, a plurality of media clients 110, 120, . . . 130 are provided access to media streams by a multicast-enabled network 100, as is well understood in the art. A media server 150 stores and multicasts particularly popular media on multiple channels 101 at different times across network 100 to satisfy client demands. Each client, e.g. client 110, issues a request to the server 150 for a media stream, otherwise referred to herein as an “arrival” at the server 150. At each arrival time, a stream is scheduled by the server 150, although for a given arrival the stream may not run until conclusion because only an initial segment of the stream is needed by the client 110. The server 150 issues a response to the client 101 that informs the client 101 which streams to monitor and for how long. The request and the corresponding response can be made using any known or arbitrary communication protocol. After this exchange, the client 101 needs no further interaction with the server 150. The client 110 receives and buffers data from two or more streams at the same time, in accordance with the response from the server 150, while a user can “play” or “view” the data accumulated in the client buffer. Each client 110 . . . 130 can receive all the parts of the media stream and play them without any interruption starting right after the time of its arrival.

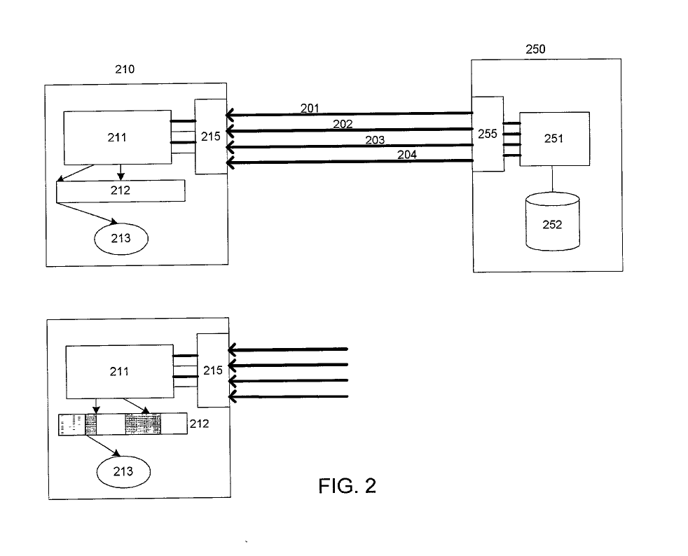

FIG. 2 is a conceptual diagram of the components of the client 210 and server 250, corresponding to the client 110 and server 150 in FIG. 1. The server 250 comprises a computational engine 251, which constructs optimized stream merging patterns, as further described herein, connected to an external or internal storage device 252 which may be used for the storage of the media stream(s). The computational engine 251 controls a network interface 255 which forwards the relevant media streams at the relevant times through the multicast network 100. Although the exact number of channels is not relevant to the invention, four multicast channels 201, 202, 203, 204 are shown in FIG. 2. The client 210 has its own network interface 215 capable of receiving data from the multicast channels 201-204. The client 210 has its own computational engine 211, which merely follows the stream merging rules and the receiving procedure described below. The client's computational engine 211 directs and stores data received from particular multicast channels to a memory buffer 212. The client 210 can have a player component 213, which is capable of presenting the data in the media stream to a user. At the top of FIG. 2, the client 210 is depicted commencing the processing of a media stream, after obtaining a receiving procedure from the server 250. As shown in the bottom of FIG. 2, the client 210 buffers the data received from two multicast channels while simultaneously sending the initial parts of the stream to the player component 213. The exact nature of the processing performed by the client 210 and the server 250 is now described in further detail.

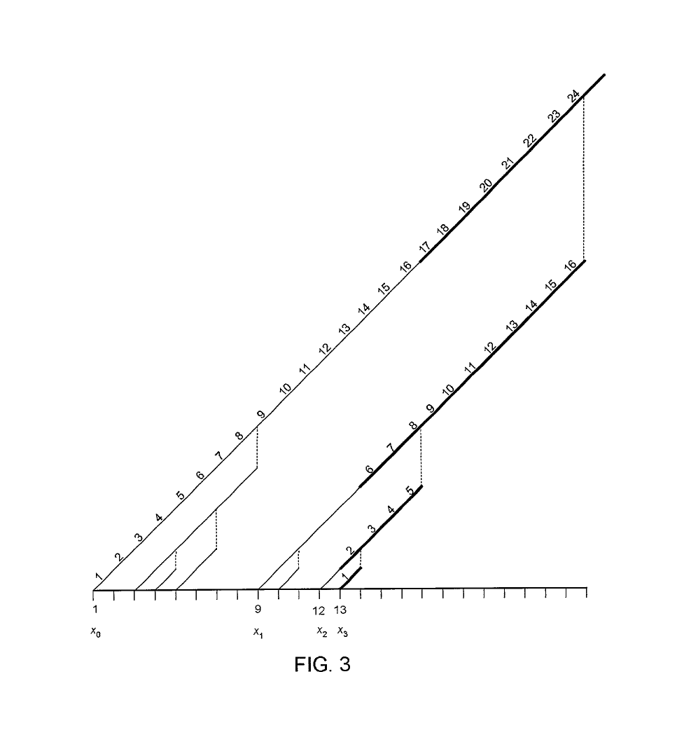

For purposes of describing the different embodiments of the invention, it is advantageous to use a discrete time model, as illustrated by the timeline shown in FIG. 3. The horizontal axis is the time axis and the vertical axis shows the particular unit of the full stream that is transmitted. Time is assumed to be slotted into unit sized intervals, each slot t starting at time t−1 where the length of a full stream is L units. Let t₁,t₂, . . . ,tₙ be a sequence of arrival times for clients. Clients that arrive at the same time slot can be considered as one client and serviced in the same manner. At each arrival time, a new stream is initiated—although for a given arrival the stream may be truncated in the context of the stream merging process. The client arrival time is used herein interchangeably to identify the client(s) arrival and the stream initiated at the particular time. The time interval can be a reflection of the delay constraints of the media streaming system: e.g. a two hour streaming movie which can tolerate a 4 minute startup delay can be configured with a time interval of 4 minutes making each movie L=30 units long. Note that although the invention is presented in the context of a discrete time model, it is readily extendible to a non-discrete time model by letting the time slots be as small as desired and where the value of L is as large as needed. FIG. 3 shows a full stream of some length L>24 commenced at time slot 1 with a series of other streams commenced at later times and truncated and merged into the full stream.

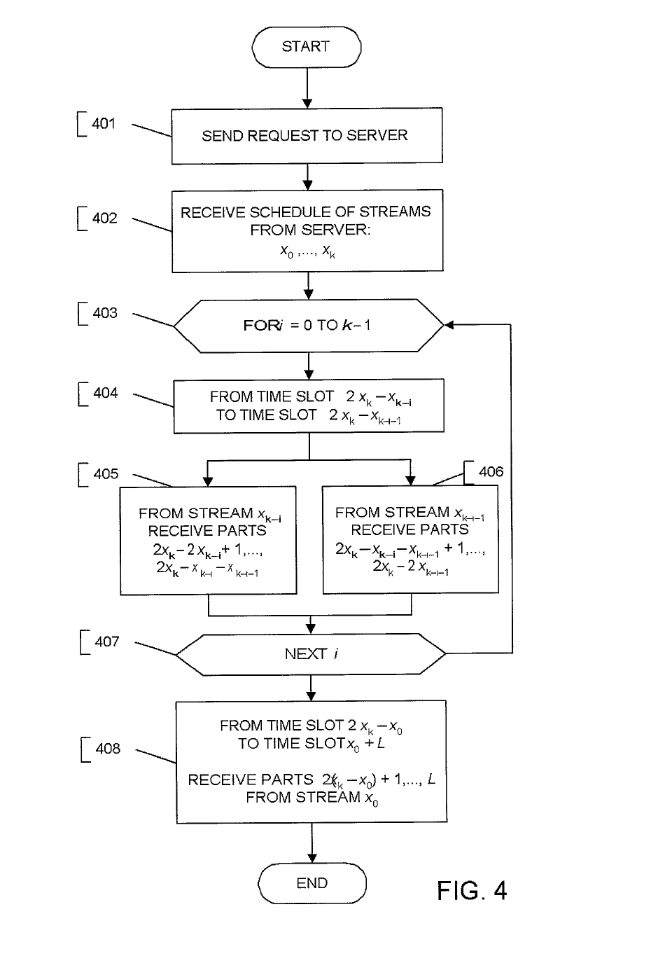

FIG. 4 is a flowchart of the processing performed by a media client 110, in accordance with a preferred embodiment of the invention. At step 401, the media client 110 issues a request for a media stream to the media server 150. As described in further detail below, the server 150 constructs a stream merging pattern and, at step 402, returns a schedule of arrival times for a plurality of k+1 streams denoted as x₀,x₁, . . . ,xₖ and referred to herein as a receiving procedure for the client. Thereafter, the client 110 needs no further communication with the media server 150 and, at steps 403 to 408, can merely “listen” to the identified multicast channel at the particular associated time periods represented in the receiving procedure. At step 403, the counter i is set to 0. From time slot xₖ until time slot 2xₖ−xₖ₋₁, the client receives different parts of the requested media stream from two different multicast channels. At 405, the client receives the beginning of the requested stream, namely parts 1, . . . , xₖ−xₖ₋₁, from stream xₖ and can immediately begin utilizing the stream. Simultaneously at 406, the client buffers the parts xₖ−xₖ₋₁+1, . . . , 2xₖ−2xₖ₋₁ from stream xₖ₋₁. At step 407, the counter i is incremented by 1 and the steps 404 to 406 are repeated until i equals k−1. From time slot 2xₖ−xₖ₋ᵢ until time slot 2xₖ−xₖ₋ᵢ₋₁, parts 2xₖ−2xₖ₋ᵢ+1, . . . , 2xₖ−xₖ₋ᵢ₋₁ are received from stream xₖ₋ᵢ while parts 2xₖ−xₖ₋ᵢ−xₖ₋ᵢ₋₁+1, . . . , 2xₖ−2xₖ₋ᵢ₋₁ are received from stream xₖ₋ᵢ₋₁. The parts are buffered and played as needed. Finally, at step 408, the last parts of the media stream 2(xₖ−x₀)+1, . . . , L are received and buffered from stream x₀ from time slot 2xₖ−x₀ until time slot x₀+L. Note that although FIG. 4 illustrates the invention with two multicast receiving streams, the invention is not limited to the “receive-two” model shown and described herein. One of ordinary skill in the art can readily extend the embodiment to multiple multicast receiving streams, although it can be shown that the benefits of adding receiving bandwidth become marginal.

The media client 110 advantageously avoids complex computations and need only follows the basic stream merging rules reflected in FIG. 4. As an example of the processing performed in FIG. 4, consider the stream merging pattern set forth in FIG. 3. A full stream of length L has already been commenced at time slot 1. The client, upon issuing a media stream request just before time slot 13, is issued a receiving procedure of streams x₀=1, x₁=9, x₂=12, x₃=13, where k=3. At time slot 13 (where the counter i=0 in FIG. 4), the client receives the first part of the stream from stream x₃ while buffering part 2 from stream x₂. For the next three time slots (i=1), the client receives and buffers parts 3-5 from stream x₂ while receiving and buffering parts 6-8 from stream x₁. For the next eight time slots (i=2), the client receives and buffers parts 9-16 from stream x₁ while receiving and buffering parts 17-24 from stream x₀. Finally at the last step in FIG. 4, the client receives the remaining parts of the stream from the full stream x₀.

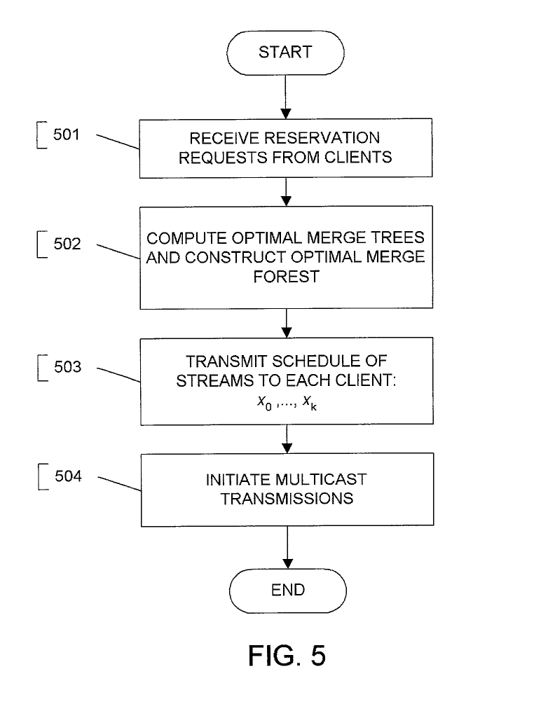

The media server 150 is responsible for computing the stream merging patterns and for disseminating the proper receiving procedures to its clients. FIG. 5 sets forth a simplified flowchart of the processing performed by the server 150 in the “off-line” situation, i.e. where the stream initiations are known ahead of time. At step 501, the server 150 receives reservation requests in advance from each of the clients. At step 502, the server 150 calculates an optimal merging schedule with corresponding receiving procedures x₀, . . . , xₖ for each client, and, at step 503, the server 150 transmits the receiving procedures to each client. At step 504, the server 150 commences the multicast transmissions, in accordance with the schedule calculated at step 502.

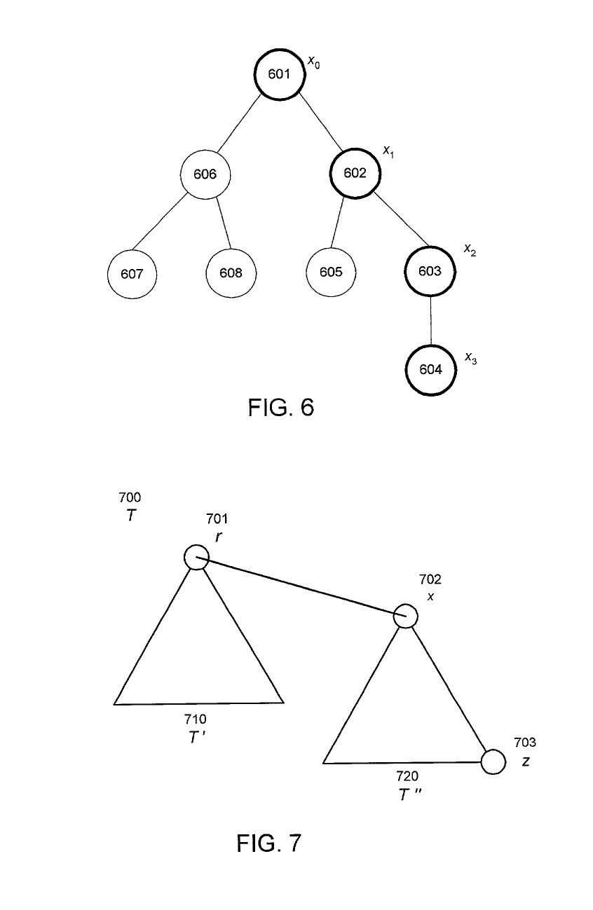

A preferred method of calculating the merging schedule would be to optimize the “cost” of different merging patterns. For example, the server could minimize the sum of the lengths of all of the streams in the merging pattern, which would be equivalent to minimizing the total number of units (total bandwidth) needed to serve all the clients. In that context, and in accordance with an aspect of the invention, FIG. 6 illustrates a particularly helpful abstraction of the diagram set forth in FIG. 3. The inventors refer to the abstraction as a “merge tree.” A merge tree is an ordered labeled tree, where each node 601-608 is labeled with an arrival time and the stream initiated at that time. For example, nodes 601, 602, 603 and 604 correspond to the arrival times/streams x₀=1, x₁=9, x₂=12, x₃=13, described above. Each new stream can only merge to an earlier stream, and the children of a given node are ordered by their arrival times. If a preordered traversal of the labeled tree yields the arrival times in order, as does the tree illustrated in FIG. 6, the tree is said to have a “preorder traversal property.” An optimized solution for a given client arrival sequence is a merging pattern which can be represented as a sequence of merge trees, which the inventors refer to as a “merge forest.”

Given a merge tree T, the root of the tree represents a full stream of length L and is denoted by r(T). If x is a node in the merge tree, l(x) is defined as the length in T; that is, l(x) is the minimum length needed to guarantee that all the clients can receive their data from stream x using the stream merging rules. A helpful distinction can be made between “merge cost” and “full cost” where the merge cost includes just the cost of merging and not the full stream which is the target of the merging. The merge cost is defined as

$$Mcost ( T ) = {\sum }_{x \neq r ( T ) ∈ T} l ( x )$$

That is, the merge cost of a tree is the sum of all lengths in the tree except the length of the root of the tree. The full cost counts everything: merging cost and full stream cost for all of the merge trees in the forest. The optimal merge cost is defined as the minimum cost of any merge tree for the sequence. An optimal merge tree is one that has optimal merge cost. There is a simple formula for calculating the minimum length required for each node of a merge tree. Let x≠r(T) be a non-root node in a tree T. Then

$$\begin{matrix}l ( x ) = 2 z ( x ) - x - p ( x ) \\ = ( z ( x ) - x ) + ( z ( x ) - p ( x ) )\end{matrix}$$

where z(x) is the arrival time of the last stream in the subtree rooted at x and p(x) is a parent of x. In particular, if x is a leaf, then z(x)=x and l(x)=x−p(x). The length of stream x is composed of two components: the first component is the time needed for clients arriving at time x to receive data from stream x before they can merge with stream p(x); the second component is the time stream x must spend until the clients arriving at time z(x) merge to p(x). Using the preorder traversal property of optimal merge trees, there is an elegant recursive formula for the merge cost of a tree T, illustrated by FIG. 7. A key property of merge trees is that for any node tᵢ, the subtree rooted at tᵢ contains the interval of arrivals tᵢ, tᵢ₊₁, . . . , tⱼ, where z(tᵢ)=tⱼ. Furthermore, tⱼ is the right most descendant of tᵢ. As a result, any merge tree can be recursively decomposed into two in a natural way as illustrated in FIG. 7. FIG. 7 shows the recursive structure of a merge tree T with root r. The last arrival to merge directly with r is x. All the arrivals before x are in T′ and all the arrivals after x are in T″ and z is the last arrival. Thus, it can be shown that

Mcost(T)=Mcost(T′)+Mcost(T″)+2z−x−r

The full cost of a forest F of s merge trees Tₗ, . . . ,Tₛ, is defined as

$$Fcost ( F ) = s \cdot L + {\sum }_{1 \leq i \leq s} Mcost ( {T}_{i} )$$

that is, the full cost of a forest is the sum of the merge costs of all its trees plus s times the length of a full transmission, one per each tree. Note that the length of any non-root nodes in T cannot be greater than L. Merge trees that do not violate this condition are referred to by the inventors as “L-trees.” The optimal full cost for a sequence is the minimum full cost of any such forest for the sequence. An optimal forest is referred to as one that has optimal full cost.

Define M (i, j) to be the optimal merge cost for the input sequence tⁱ, . . . , tⱼ. The optimal cost for the entire sequence, thus, is M(l,n) . The optimal cost may be computed using dynamic programming. M (i, j) can be recursively defined as follows

$$M ( i , j ) = {min}_{i < k \leq j} \{ M ( i , k - 1 ) + M ( k , j ) + ( 2 {t}_{j} - {t}_{k} - {t}_{i} ) \}$$

with the initialization M (i,i)=0. This recursive formulation naturally leads to an O(n³) time algorithm using dynamic programming, as is well understood in the art. The time to compute the optimal merge cost may be reduced to O(n²) be employing the classic technique of monotonicity. See, e.g., D. E. Knuth, “Optimum Binary Search Trees,” Acta Informatica, Vol. 1, 14-25 (1971). Define r(i,i)=i and, for i<j, as follows:

r(i,j)=max{k: M(i,j)=M(i,k−1)+M(k,j)+2tⱼ−tₖ−tₗ}

Thus, r(i,j) is the last arrival that can merge to the root in some optimal merge tree for tᵢ, . . . , tⱼ. Monotonicity is the property that for 1≦i<n and 1<j≦n

r(i,j−1)≦r(i,j)≦r(i+1,j)

It should be noted that there is nothing special about using the max in the definition of r(i,j); the min would yield the same inequality. Monotonicity can be demonstrated using a very elegant method of quadrangle inequalities. See F. F. Yao, “Efficient Dynamic Programming Using Quadrangle Inequalities,” Proceedings of the 12^{th} Annual ACM Symposium on Theory of Computing (STOC '80), 429-35 (1980); A. Borchers and P. Gupta, “Extending the Quadrangle Inequality to Speed Up Dynamic Programming,” Information Processing Letters, Vol. 49, 287-90 (1994). Thus, the search for the k in the above recursive formulation can be reduced to r(i+1,j)−r(i,j−1)+1 possibilities from j−1 possibilities. The key point is that the right most stream that merges to the root of an optimal tree from i to i+j is confined to an interval and these intervals are almost disjoint for i not equal to j.

An optimal algorithm for calculating the full cost uses the optimal algorithm for merge cost above as a subroutine. Let t₁,t₂, . . . ,tₙ be a sequence of arrivals, and let L be the length of a full stream. For 1≦i≦n, define G(i) to be the optimal full cost for the last n−i+1 arrivals to tₗ, . . . ,tₙ. Define G(n+1)=0 and for 1≦i≦n,

G(i)=L+min{M(i,k−1)+G(k):i<k<n+1 and tₖ₋₁−tₗ≦L−1}

The optimal full cost is G(1) and the order of computation is G(n+1),G(n), . . . ,G(1). The optimal full cost algorithm proceeds in two phases. In the first phase, the optimal merge cost M (i,j) is computed for all i and j such that 0≦tⱼ−tₗ≦L−1, so that these values can be used to compute G(i) . In the second phase, G(i) is computed from i=n down to 1 using the above equation. The intuition for the above is as follows: a full stream must begin at t₁, and there are two possible cases in an optimal solution. Either all the remaining streams merge to this first stream or there is a next full stream tₖ for some k≦n. In the former case, the optimal full cost is simply L+M (l,n). In the latter case, the optimal full cost is L+M (1, k−1) plus the optimal full cost of the remaining arrivals tₖ, . . . ,tₙ. In both cases, the last arrival to merge to the first stream must be within L−1 of the first stream. The full streams can be identified inductively. Both phases of the optimal algorithm together run in time O(nm), where m is the average number of arrivals in an interval of length L−1 that begins with an arrival. The above algorithm is practical enough to schedule millions of reserved arrivals.

An important special case which simplifies the above optimal merge cost solution is when an arrival is scheduled at every time unit, referred to herein as the “fully loaded arrivals” case. The fully loaded arrivals case can be thought of as being a system with a guaranteed maximum delay, where streams are scheduled at every time unit regardless of client arrivals. For the case of fully loaded arrivals, the value M(i,j) does not depend on i(tᵢ) and j(tⱼ) but rather depends on their difference j−i. Hence, where M(n) is the minimum cost for a merge tree for the arrivals [0, n−1], the following recursive formula for the merge cost for fully loaded arrivals is obtained.

$$M ( n ) = {min}_{1 \leq h \leq n - 1} \{ M ( h ) + M ( n - h ) + 2 n - h - 2 \}$$

with the initialization M(l) =0. Using the notation above, the term 2n−h−2 comes from z=n−1, x=h, and r=0 and then 2z−x−r=2n−h−2. Calculating M(n) for small values of n yields an interesting sequence:

| | | | | | | | | | | | | | | | | |
|---|---|---|---|---|---|---|---|---|---|---|---|---|---|---|---|---|
| n | 1 | 2 | 3 | 4 | 5 | 6 | 7 | 8 | 9 | 10 | 11 | 12 | 13 | 14 | 15 | 16 |
| M(n) | 0 | 1 | 3 | 6 | 9 | 13 | 17 | 21 | 26 | 31 | 36 | 41 | 46 | 52 | 58 | 64 |

A careful examination of this sequence reveals that there is a very elegant formulation of the merge cost in terms of Fibonacci numbers:

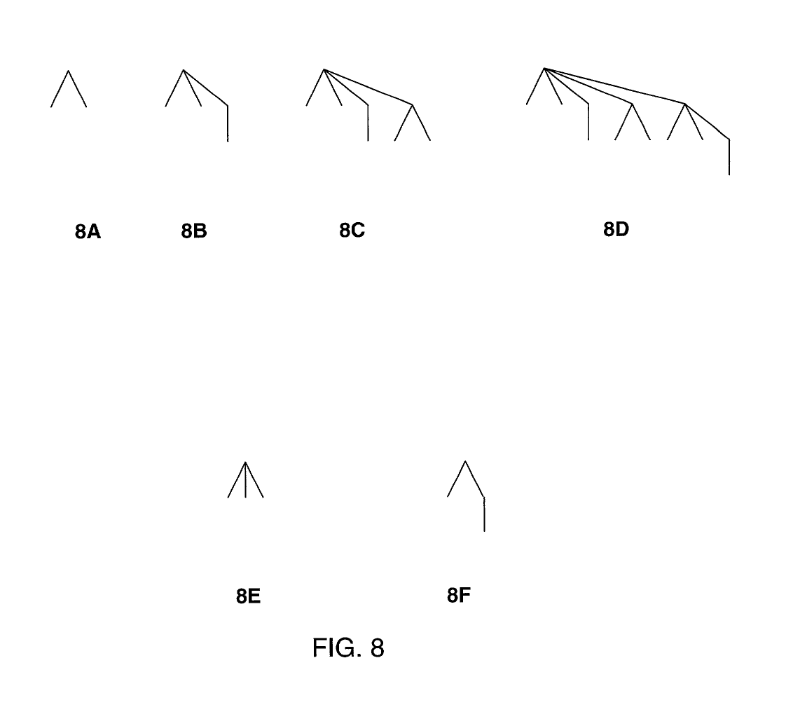

M(n)=(k−1)n−Fₖ₊₂+2 if Fₖ≦n≦Fₖ₊₁

where Fₖ is the kth Fibonacci number. As is well known in the art, the Fibonacci numbers are defined by the following recurrence: Fₖ=Fₖ₋₁+Fₖ₋₂ for k≧2, where F₀=0 and F₁=1. It can be shown that for n equal to a Fibonacci number there is a unique optimal tree, which the inventors refer to as a “Fibonacci merge tree.” FIG. 8A through 8D illustrate such optimal trees for n=3, 5, 8, 13, with corresponding merge costs of M(n)=3, 9, 21, 46, respectively. Note the structure of these optimal trees: the right-most subtree of the tree for n=Fₖ is the tree for n=Fₖ₋₂ whereas the rest of the tree to the left is a tree for n=Fₖ₋₁. On the other hand, for other values of n there can be multiple optimal trees, e.g., FIG. 8E and FIG. 8F illustrate two optimal trees for four arrivals, both trees having a merge cost of six. It is of interest to see which arrivals can be the last to merge in an optimal merge tree. Define the following two auxiliary functions:

H(n,h)=M(h)+M(n−h)+2n−h−2

I(n)={h: M(n)=H(n,h)}

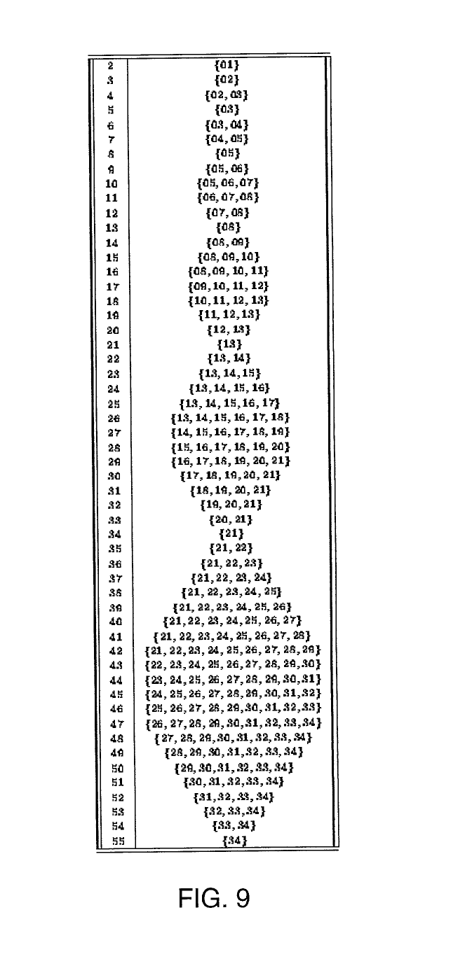

so that the value of M(n) can be determined by minimizing H(n, h) for 1≦h≦n−1. The members of I(n) are all the arrivals that can be the last merge to the root in an optimal merge tree for [0, n−1]. FIG. 9 shows the values of l(n) for 2≦n≦34. Each set I(n) is an interval and the pattern depends heavily on Fibonacci numbers. The following definitions are useful in characterizing these intervals. For a given n, n=Fₖ+m for some 0≦m≦Fₖ₋₁, define the following three intervals:

I₁(n)=[Fₖ₋₁, Fₖ₋₁+m]

I₂(n)=[Fₖ₋₂+m,Fₖ₋₁+m]

I₃(n)=[Fₖ₋₂+m,Fₖ]

A given interval Iᵢ(n) will be the I(n) for a certain range of m in the interval [0, Fₖ₋₁]. Define those ranges as:

m₁(k)=[0, Fₖ₋₃]

m₂(k)=[Fₖ₋₃, Fₖ₋₂]

m₃(k)=[Fₖ₋₂, Fₖ₋₁]

Then it can be shown by induction that if mεmᵢ(k),

M(n)=(k−1)n−Fₖ₊₂+2 and I(n)=Iᵢ(n)

which can be used as the basis of an efficient algorithm to construct an optimal merge tree for fully loaded arrivals.

An optimal merge tree for fully loaded arrivals can thus be computed in time O(n) using the above closed form solution. Let [0, n−1] be an input. Define r(i)=max I(i) for 1≦i≦n. So r(i) is an arrival that can be the last merge in an optimal merge tree for the input [0, i−1]. An optimal merge tree for the input [i,j] can be computed using the following recursive procedure. If i=j return the tree with label i. Otherwise, recursively compute the merge tree T₁ for the input [i,i +r(j−i+1)−1] and T₂ for [i+r(j−i+1), j], then attach the root of T₂ as an additional last child of the root of T₁ and return the resulting tree. This procedure is called for the input [0, n−1] to construct an optimal merge tree. With an elementary data structure the tree can be constructed in linear time provided that r(i) has already been computed for 1≦i≦n. The Fibonacci numbers≦n, can be computed in O(log n) time. The sequence r(1), r(2), . . . , r(n) can be computed in linear time using the recurrence

$$\begin{matrix}r ( i ) = r ( i - 1 ) + 1 & if {F}_{k} < i \leq {F}_{k} + {F}_{k - 2} \\ = r ( i - 1 ) & if {F}_{k} + {F}_{k - 2} < i \leq {F}_{k + 1}\end{matrix}$$

with the initialization r(1)=0 and r(2)=1. An optimal forest for fully loaded streams can be constructed in linear time. In computing the full cost of a merge forest, the cost of the roots must be taken into account. There are basically two steps: first, determine how many full streams are in an optimal merge forest and, second, where to place the full streams. Define F(L, n, s) to be the minimum cost of any merge forest for [0, n−1] where the length of a full stream is L and there are exactly s roots (full streams). Since at most L−1 streams can merge with a stream of length L, it follows that for a given n there must be at least s₀=[n/L] full streams for n arrivals. Hence,

$$F ( L , n ) = {min}_{{s}_{0} \leq s \leq n} F ( L , n , s )$$

Notice the extreme cases: L=1 implies s₀=n and n=L−1 implies s₀=1. For a fixed s, the placement of the full streams in an optimal merge forest with s full streams can be determined. Where n=ps+r and 0≦r<s, it can be shown that

F(L,n,s)=sL+rM (p+1)+(s−r)M(p)

This yields a straightforward linear time algorithm for computing an optimal merge forest. First, the above-described Fibonacci formulation of M can be used to compute M(1), M(2), . . . , M(L). Next, search for an s (s₀≦s≦n) that minimizes sL+rM(p+1)+(s−r)M(p) where p=└n/s┘ and r=n−ps. To construct the merge forest, place r full streams at 0, p+1,2(p+1), . . . , (r−1)(p+1) and s−r full streams at r(p+1),r(p+1)+p,r(p+1)+2p, . . . ,r(p+1)+(s−r−1)p . Use the linear time algorithm for constructing an optimal merge tree to complete the forest. The optimal merge forest for fully loaded arrivals can be computed in O(L+n) time. Note that it is possible to directly calculate the number of full streams needed in an optimal merge forest rather than searching for the s that minimizes the above expression. First, compute h such that Fh_{H+1}<L+2≦Fₕ₊₂. This h can be computed in linear number of log operations. Next, compute s₁=└n/Fₕ┘ and s₀=└n/L┘. If s₀>s₁ then s₀=s₁+1 minimizes F(L, n, s). Otherwise, compute F(L, n, s₁) and F(L, n, s₁₊₁) using the above expression. If the former value is smaller, then s₁ minimizes F(L, n, s), otherwise s₁+1 does. It is interesting to note that there are cases where s₁ is optimal and s₁+1 is not, s₁+1 is optimal and s₁ is not, and both s₁ and s₁+1 are optimal. It should be noted that a natural guess for s is ┌n/(└L/2┘+1)┌. That is, a full stream is scheduled at intervals of length about L/2 and each tree contains about L/2 nodes. This value of s is not always optimal, but it is optimal in many cases and at the very least gives a good upper bound for the full cost in the fully loaded arrivals case.

In contrast to the off-line situation in which client reservations are accepted in advance, we next describe the “on-line” situation in which the client requests are not known ahead of time. When a new client t, arrives, the media server 150 is assumed to have already constructed a merge forest Fₙ₋₁ for the preceding n−1 clients, t₁, . . . , tₙ₋₁ where t₁ is the root of the first merge tree in the forest. Given n>1, a decision must be made to either incorporate tₙ into the last merge tree in the forest or to start a new merge tree by making tₙ its root. The goal in the on-line situation is to obtain results dynamically that are good relative to an after-the-fact off-line computation.

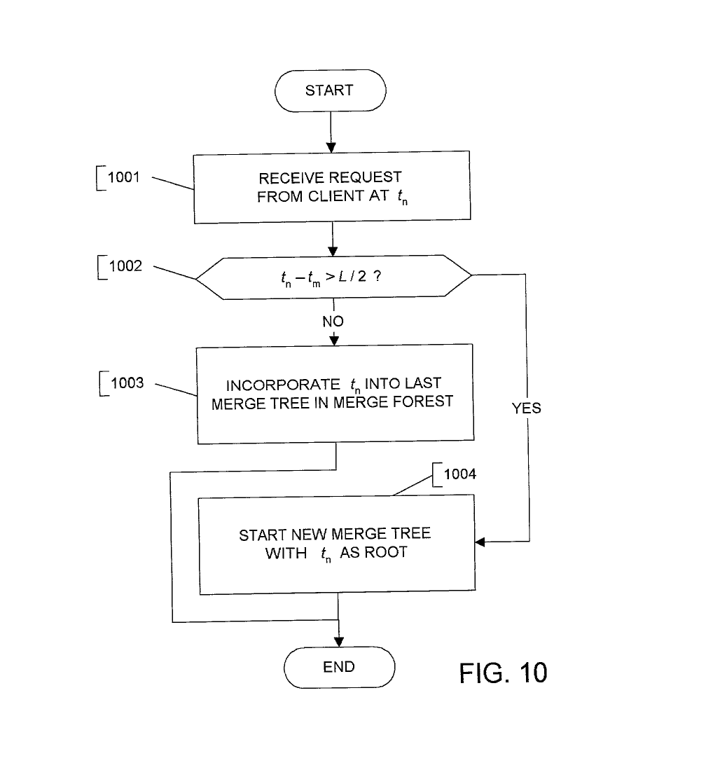

FIG. 10 sets forth a simplified flowchart of the processing performed by the server 150 in the on-line situation, in accordance with a preferred embodiment of the invention. At step 1001, the server 150 receives the request from the client at time slot tₙ. At step 1002, the server 150 compares tₙ−tₘ to the quantity L/2, where tₘ is the last root of a merge tree in the merge forest Fₙ₋₁. If tₙ−tₘ>L/2, then, at step 1004, the server 150 starts a new merge tree with tₙ becoming the root of the new merge tree in Fₙ. This start rule has many justifications. First, if tₙ−tₘ≦L/2 then tₙ can always be incorporated into the merge tree rooted at tₘ, and for tₙ−tₘ time slots the clients served by tₙ will be receiving two streams simultaneously. Second, there is a serious disadvantage of trying to incorporate tₙ into merge tree rooted at tₘ if tₙ−tₘ<L/2. Consider the extreme example where tₘ=tₙ−1 and tₙ=tₙ−1+L−1. In this example, tₙ can merge directly to tₙ₋₁ so that l(tₙ)=L−1. However, stream tₙ only receives one part of tₙ₋₁, namely, its last part. Even worse, no future arrival can receive any part of tₙ because doing so would cause the length of stream tₙ to exceed L. The only potential gain in merging tₙ to tₙ₋₁ is if there are no arrivals in the next L slots after tₙ.

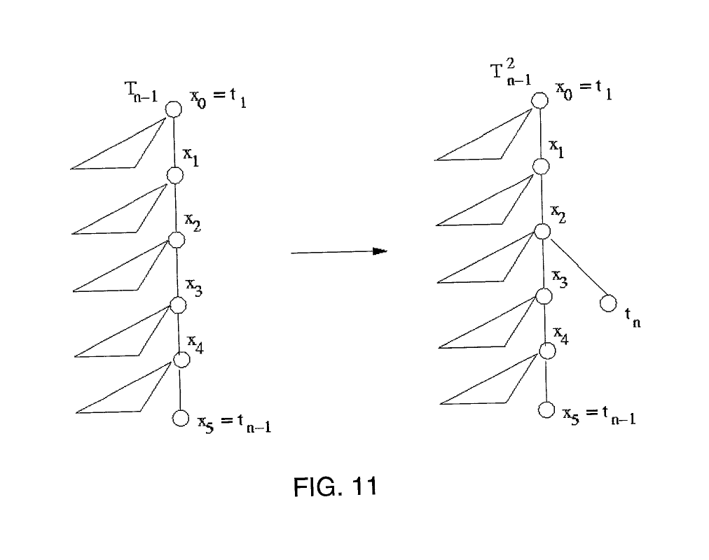

Assuming no new merge tree will be created, the server 150 must then decide how to incorporate the new arrival into the existing merge tree at step 1003. A new merge tree Tₙ will then be created which incorporates the arrival tₙ into the existing merge tree, referred to as Tₙ₋₁ for arrivals t₁, . . . , tₙ₋₁. In order to preserve the preorder labeling (and thereby the existing stream merging rules), the new arrival should be merged into the “right frontier” of the existing merge tree. The right frontier of Tₙ₋₁ is the path t₁=x₀, x₁, . . . , xₖ=tₙ₋₁ where xᵢ₊₁ is the right most child of xᵢ for 0≦i<k. For example, consider the case of a new arrival at time slot 15 in FIG. 3. As reflected on the corresponding merge tree in FIG. 6, the right frontier of the merge tree comprises the nodes 601-604. The pre-order traversal property of the tree requires that some node on the right frontier be made the parent of the new arrival at slot 15. Note, however, that not every node on the right frontier is eligible to be a parent of the new arrival. The arrival at time slot 15 cannot merge with node 604 because the stream X₃ has already terminated. Thus, the arrival can be merged into the root at 601 (stream x₀) or into the remaining nodes 602 (stream x₁) or 603 (stream x₂). This basic merging rule can be expressed more formally as requiring that Tₙ=Tₙ₋₁⁰ or Tₙ=Tₙ₋₁ⁱ for some i>0 such that tₙ≦2tₙ₋₁−xᵢ₋₁, where Tₙ₋₁ⁱ is defined to be the tree Tₙ₋₁ with xᵢ chosen as the parent of tₙ, that is, P_{T}_{ₙ₋₁}^{l}(tₙ)=xₗ. This transition from Tₙ₋₁ to Tₙ₋₁ⁱ is further illustrated abstractly by FIG. 11. Note that the new right frontier of Tₙ₋₁ⁱ is t₁=x₀,x₁. . . ,xᵢ, tₙ.

The incremental cost of merging tₙ into Tₙ₋₁ can be expressed as:

MCost(Tₙ)−MCost(Tₙ₋₁)=2i(tₙ−tₙ₋₁)+tₙ−xₗ

where the last part of the cost, tₙ−xₗ, is the length of tₙ and the first part of the cost represents the length of each non-root ancestor of tₙ due to the change of its last descendant from tₙ₋₁ to tₙ. A simple approach to optimizing on-line streaming would be to choose a parent so as to minimize the incremental merge cost, which the inventors refer to as a “best fit” rule. Another approach would be to pick a parent which is “closest” in some sense to the new arrival, which the inventors refer to as the “nearest fit” rule. For example, the largest i could be chosen where the i-th parent has not yet terminated. Unfortunately, it can be shown that these approaches do not have good performance relative to off-line stream merging.

Instead, and in accordance with another aspect of the invention, it can be shown that it is advantageous to force the on-line algorithm to “follow” an on-line merge tree as closely as possible. The on-line tree acts as a kind of “governor” in a tree-fit algorithm where each new arrival must merge with a member of the right frontier of the on-line merge tree. First, consider the situation of a fixed merging pattern, where the sequence of arrivals is not known in advance, but its length is assumed to be n. A fixed unlabeled tree T with n nodes, referred to by the inventors as a “static” merge tree, is utilized in an “oblivious” off-line merging process, which can be considered a “semi” on-line algorithm. Given an arrival sequence τ=(t₁, . . . ,tₙ), a merge tree T(τ) is constructed with the same structure as T, but with the labels t₁, . . . , tₙ put on the nodes in a preorder fashion. Hence, given two arrival sequences τ≠τ′, it could be the case that Mcost(T(τ))≈Mcost( T(τ′)). How well a static merge tree T performs can be expressed as an approximation ratio a_{T} defined as follows:

$${a}_{T} = sup \{ \frac{MCost ( T ( τ ) )}{{M}_{opt} ( τ )} : τ is an arrival sequence of length n \}$$

This quantity measures the worst case performance of the static tree T as compared with optimal. It turns out that the approximation ratio of a static merge tree can be exactly characterized by measuring what the inventors refer to as its “extent.” For a static merge tree T and a node x in T, define u_{T}(x) to be the number of ancestors of x not counting x and the root of T, and define ν_{T}(x) to be the number of right siblings of ancestors of x (including x). The extent of x is defined to be:

e_{T}(x)=2u_{T}(x)+ν_{T}(x)+1

while the extent of the static merge tree T is:

e(T)=max{e_{T}(x): x in T}

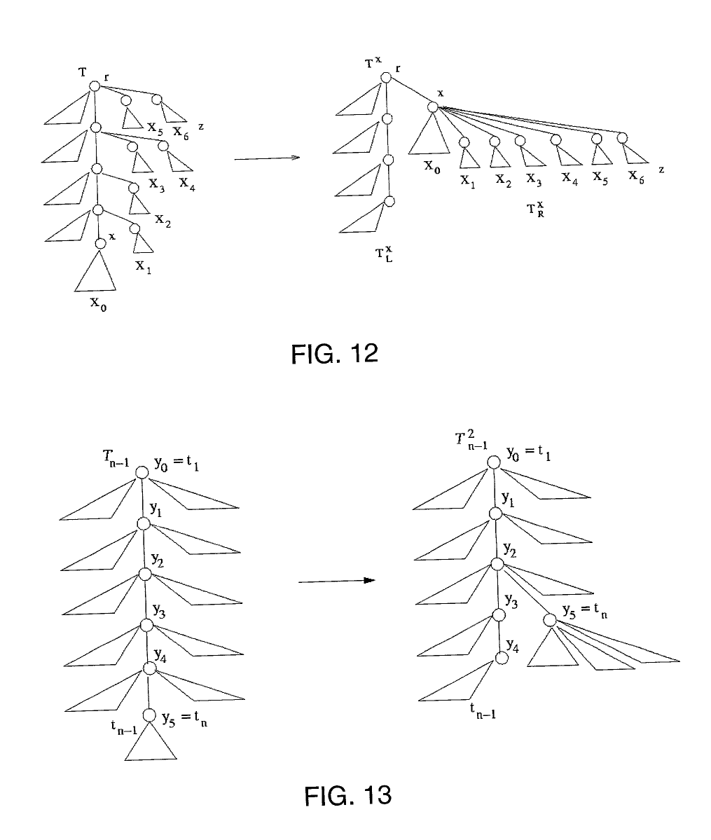

For any static merge tree T, it can be shown that a_{T}=e(T). The extent can be shown to be a lower bound of the approximation ratio by example. The extent can also be shown to be an upper bound by induction on the number of nodes in T using a transformation of T to an optimal T^{x}. The goal of the transformation is to make x, a node in T which is not the root, the last child of the root of T^{x}. The tree T^{x} is formed from two trees T_{L}^{x} and T_{R}^{x} as follows. First, T_{L}^{x} is the subtree of T consisting of all nodes that come before x in a preorder traversal of T. What remains from T after T_{L}^{x} is a sequence of disconnected merge trees X₀, X₁, . . . , Xₖ where X₀ is the subtree of T rooted at x and Xᵢ₊₁ is the subtree of T that is traversed in a preorder traversal of T immediately after Xᵢ is traversed. The merge tree T_{R}^{x} is formed by taking X₀ whose root is x and making x the parent of the root of each Xₗ for 1≦i≦k in that order. The transformation from T to T^{x} is illustrated in FIG. 12. Note that T_{L}^{x} is the subtree of T^{x} of all arrivals before x and T_{R}^{x} is the subtree of T^{x} of all arrivals after and including x. This corresponds to the subtrees T′ and T″, respectively shown in FIG. 7. As a byproduct of the construction the subtree to the left of the last merge and the subtree rooted at the last merge each have extent less or equal to the extent of T. If the costs of the move are carefully examined, it can be shown that the cost is bounded by e(T)−1 times the cost of x in T^{x}. The extent, and accordingly the approximation ratio for any static merge tree, can be shown to have a lower bound of log_{φ}n−1, where φ=(1+\sqrt{5})/2≈1.618 is the golden ratio and is the positive root of the equation x²=x+1. Furthermore, it is advantageous to note that the extent of a Fibonacci tree is essentially the same as the lower bound.

Given the knowledge of the approximation ratio for static trees, a new class of dynamic tree algorithms can be defined. Define a “preorder tree” to be an infinite tree in which the root has an infinite number of finite size subtrees as its children. Such a tree has the property that the preorder traversal provides a numbering for the entire tree starting with the root numbered 1. Define T[n] to be the finite subtree of T of the nodes numbered 1 to n. An “infinite merge tree” is a preorder tree labeled with the arrival sequence t₁, t₂, . . . in preorder fashion. An advantageous example of a preorder tree what the inventors refer to as the infinite Fibonacci tree F. Define the finite Fibonacci trees FT₁, FT₂, . . . as follows. The trees FT₁ and FT₂ are each signal nodes. The tree FTₖ is formed from FTₖ₋₁ and FTₖ₋₂by making the root of FTₖ₋₂the last child of the root of FTₖ₋₁. It should be clear from the construction of FTₖ that its size is Fₖ. Furthermore, it can be shown by induction that the extent e(FTₖ)=k−2 for k>2. Define F as a root with infinitely many children where the kth child is the root of the subtree FTₖ. A preorder traversal of F defines the preorder numbering of the nodes with the root numbered 1. Define F[n] to be the subtree of F consisting of the n nodes numbered from 1 to n. Then, it can be shown for k≧2, F[Fₖ]=FTₖ. The infinite Fibonacci tree yields static trees with almost minimal approximation ratio. For n>1, it can be shown that a_{f[n]}≦|log_{φ}n|. Thus, the approximation ratio of F [n] is within 1 of the lower bound for all static trees of size n. If n is a Fibonacci number then F[n] has the minimum approximation ratio for a static tree of its size.

In accordance with an embodiment of an aspect of the invention, a dynamic tree algorithm proceeds by producing a new infinite merge tree for each new arrival. Suppose that T_{N-1} is the infinite merge tree after processing the arrivals t₁, . . . , t₂,. Let t₁=y₀, y₁, . . . , yₖ₊₁=tₙ be the path from the root to tₙ in Tₙ₋₁. For each i≦k, we define Tₙ₋₁ⁱ which is formed from Tₙ₋₁ as follows. Let Cₗ={x:p(x)=yᵢ and x>tₙ}. So x ε Cₗ if x is a child of yₗ arriving later than tₙ. Define Tₙ₋₁^{l} to be the tree Tₙ₋₁ modified so that p_{T}_{ₙ₋₁}ⁱ(tₙ)=yₗ and p_{T}_{ₙ₋₁}^{l}(x)=tₙ for all j>i and x ε Cᵢ. See FIG. 13 for an illustration of the transformation Tₙ₋₁ to Tₙ₋₁ⁱ. The dynamic tree algorithm for T satisfies the following formal rule: either Tₙ=Tₙ₋₁⁰ or Tₙ=Tₙ₋₁^{l} for some i such that 0<i≦k and tₙ≦2tₙ₋₁−yᵢ₋₁. This is a special case of the basic merging rule described above. The path y₀, . . . , yₖ is a prefix of the right frontier, which is the path from y₀ to tₙ₋₁. It should be noted that although Tₙ₋₁ is fully labeled with arrivals (suggesting that it is necessary to know the future arrivals and maintain an infinite tree), it can be assumed for implementation purposes that it is only labeled with the known arrivals t₁, . . . , tₙ₋₁. The algorithm knows the structure of the tree Tₙ₋₁ so that when tₙ becomes known it is made the label of the nth node in the tree. It can be seen inductively that Tₙ is an infinite preorder tree if Tₙ₋₁ is an infinite preorder tree. The tree T is, by definition, composed of infinitely many finite trees T₁, T₂, . . . , whose root is a child of the root of T. The tree Tᵢ₋₁ is numbered before the tree Tᵢ in a preorder traversal of T. Let nᵢ be 1 plus the sum of the sizes of Tⱼ for j>i. As long as n≦nᵢ, only that part of T that includes the first i trees need be maintained. When n=nᵢ+1, the next tree Tᵢ₊₁ can be incorporated into the algorithm. This can be done because if n≦nₗ, the transition from Tₙ to Tₙ₋₁ⁱ leaves fixed all the trees Tⱼ for j>i.

It would be advantageous that the new tree, in the transition from Tₙ to Tₙ₋₁ⁱ, be just as effective as the old tree for future arrivals in order for the dynamic tree algorithm to behave well. This turns out to be true if the algorithm is “cost-preserving,” meaning that the new tree Tₙ=Tₙ₋₁ⁱ for some 0<i≦k such that yᵢ−yₖ+2(k−i)(tₙ−tₙ₋₁)≦0. It can be shown that if this condition is true, then Mcost(Tₙ₋₁[m])≧Mcost(Tₙ₋₁ⁱ[m]) for all m≧n. It can then be shown that if A is a dynamic tree algorithm for T that satisfies the cost preserving rule, then for all n, c_{A} (n)≦a_{T[n]}. Thus, the competitive ratio performance of the dynamic tree algorithm can be related with the approximation ratio of the static trees. Two classes of algorithms can be easily shown to satisfy the cost preserving rule, and therefore are bounded above by the approximation ratios of the prefixes of T, a_{T[n]}: the “best fit” dynamic tree algorithm and the “nearest fit” dynamic tree algorithm for T. The “best fit” algorithm satisfies the rule that Tₙ=tₙ₋₁ⁱ for an i that minimizes Δ_{i,n}=2i(tₙ−tₙ₋₁)+tₙ−yₗ. The “nearest fit” algorithm satisfies the rule that Tₙ=Tⁿ⁻¹⁰ if tₙ>2tₙ₋₁−yₗ₋₁ for all 0<i≦k and Tₙ=Tₙ₋₁ⁱ if i is the largest number such that tₙ≦2tₙ₋₁−yₗ₋₁.

Since the infinite Fibonacci tree F has the best approximation ratios in the static situation, it makes sense to use it in a dynamic tree algorithm. Where the best fit dynamic tree algorithm uses an infinite Fibonacci tree (referred to by the inventors as a “best fit dynamic Fibonacci tree (BFDT) algorithm”) and where the nearest fit dynamic tree algorithm uses an infinite Fibonacci tree (referred to by the inventors as a “nearest fit Fibonacci tree (NFDT) algorithm”), it can be shown that the merge cost competitive ratios are bounded by |log_{φ}n|. For the case in which there is an arrival every time slot, both algorithms have a constant competitive ratio. They are optimal when n is a Fibonacci number, since the Fibonacci tree is the optimal merge tree for such sequences, as discussed above. This is not the case with other values of n=Fₖ+m, for k≧3 and 0<m <Fₖ₋₁. In this case, the optimal tree divides the arrivals into the left and the right subtrees according to the golden ratio. On the other hand, the size of the left subtree is always Fₖ. Nevertheless, the loss is not too big, and the competitive ratio is constant. Moreover, it can be shown that there is a bound on the full cost competitive ratios of the algorithms. Expressed using the parameter D=1/L (which can be interpreted as the guaranteed maximum startup delay measured as a percentage of the stream length), the full cost competitive ratios of the best and nearest fit dynamic Fibonacci tree algorithms are bounded above by:

min{|log_{φ}(1/(2D))|+2,|log_{φ}(n)|+2}

When D is very small the competitive ratio in the full cost is O(log n) as is the competitive ratio for the merge cost. In the extreme, when D tends to zero, this models situations in which arrivals could happen at any time. However, it is very realistic to assume that n is very large and D is a constant. That is, clients tolerate some delay and the time horizon is long. In this case, the above equation yields a constant competitive ratio bound. As an example, suppose there is a two hour video with a guaranteed maximum delay of 4 minutes. Then L=30 and D=1/30 or about 3.33%. The best fit and nearest fit dynamic Fibonacci tree algorithms have competitive ratios bounded above, according to the above equation, by 8. Hence, it is known that these algorithms will never use more than 8 times the bandwidth required by an optimal off-line solution—and in common case arrivals will perform even better.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, many of the examples and equations have been presented in the context of a model in which the client receives data from two multicast channels. One of ordinary skill in the art can readily extend the various aspects of the above invention to clients that receive data from more than two multicast channels.

What is claimed is:

1. A method of streaming media to a client comprising:
receiving a request from a client for a media stream;
computing a receiving procedure for the client;
transmitting the receiving procedure to the client;
initiating a first multicast stream such that the client can utilize the receiving procedure to receive a first portion of the media stream from the first multicast stream and a second portion of the media stream from a second multicast stream.

2. The invention of claim 1 wherein the client can further utilize the receiving procedure to receive a third portion of the media stream from a third multicast stream.

3. The invention of claim 1 wherein the receiving procedure is computed after a step of computing a merge tree incorporating the request from the client.

4. The invention of claim 3 wherein the merge tree is a Fibonacci merge tree.

5. A method of streaming media to a plurality of clients comprising:
receiving reservation requests for a media stream from a plurality of clients;
constructing a merge tree based on the reservation requests;
scheduling a plurality of multicast transmissions of the media stream based on the merge tree.

6. The invention of claim 5 wherein the merge tree is constructed to minimize the cost of the merge tree.

7. The invention of claim 6 wherein the merge tree is a Fibonacci merge tree.

8. The invention of claim 5 wherein the merge tree is constructed to minimize the cost of a forest of merge trees further comprising the merge tree.

9. A method of streaming media to a plurality of clients comprising:
constructing a merge tree based on anticipated requests for a media stream;
scheduling a plurality of multicast transmissions of the media stream based on the merge tree.

10. The invention of claim 9 wherein the anticipated requests for the media stream are scheduled to arrive at every time unit.

11. The invention of claim 10 wherein the merge tree is a Fibonacci merge tree.

12. The invention of claim 9 wherein the merge tree is a static merge tree with a fixed number of nodes.

13. A method of streaming media to a client comprising:
receiving a request from a client for a media stream;
taking a first merge tree further comprising a right frontier and constructing a second merge tree which incorporates the request into the right frontier of the first merge tree; and
scheduling a plurality of multicast transmissions of the media stream, including a multicast transmission to the client, based on the second merge tree.

14. The invention of claim 13 wherein the second merge tree is constructed to minimize an incremental merge cost.

15. The invention of claim 13 wherein the second merge tree is constructed such that the request is represented as a node of a parent node in the first merge tree closest to the node.

16. The invention of claim 13 wherein the second merge tree is an infinite merge tree.

17. The invention of claim 16 wherein the infinite merge tree is an infinite Fibonacci merge tree.

18. A machine-readable medium comprising executable program instructions for performing a method on a computer comprising the steps of:
transmitting a request for a media stream to a server;
obtaining a receiving procedure from the server;
in accordance with instructions in the receiving procedure, receiving and buffering a first portion of the media stream from a first multicast channel while receiving and buffering a second portion of the media stream from a second multicast channel.
